(19) United States
(12) Patent Application Publication
(10) Pub. No.: US 2025/0135532 A1
(43) Pub. Date: May 1, 2025

(54) A PROCESS FOR THE TREATMENT OF AT LEAST ONE THREE-DIMENSIONAL GREEN BODY

(71) Applicant: BASF SE, Ludwigshafen am Rhein (DE)

(72) Inventor: Tobias ROEDLMEIER, Heidelberg (DE)

(21) Appl. No.: 18/838,673

(22) PCT Filed: Feb. 17, 2023
(86) PCT No.: PCT/EP2023/054058

§ 371 Date: Aug. 15, 2024

(30) Foreign Application Priority Data
Feb. 18, 2022 (EP) 22157616.8

(51) Int. Cl. B22F 3/10; B22F 3/22; B22F 10/18; B22F 10/62; B33Y 10/00; B33Y 40/00

(52) U.S. Cl. CPC B22F 3/1025; B22F 3/225; B22F 10/18; B22F 10/62; B22F 2999/00; B33Y 10/00; B33Y 40/00

(57) ABSTRACT

The present invention relates to a process for the treatment of at least one three-dimensional green body (GB), wherein the at least one three-dimensional green body (GB) comprises an inorganic powder (IP) and a binder (B), the binder (B) comprising as component (b1) at least one polyoxymethylene (POM). In this process, 0.01 to 5.0% by weight of anhydrous oxalic acid, based on the total weight of the at least one three-dimensional green body (GB), are provided with which the at least one three-dimensional green body (GB) is treated at a temperature (T1)<140° C. in the presence of an inert gas. The present invention further relates to a three-dimensional brown body (BB) prepared by this process and to a three-dimensional sintered body (SB) prepared from the three-dimensional brown body (BB). Furthermore, the present invention relates to an apparatus, in which this process is carried out.

The present invention relates to a process for the treatment of at least one three-dimensional green body (GB), wherein the at least one three-dimensional green body (GB) comprises an inorganic powder (IP) and a binder (B), the binder (B) comprising as component (b1) at least one polyoxymethylene (POM). In this process, 0.01 to 5.0% by weight of anhydrous oxalic acid, based on the total weight of the at least one three-dimensional green body (GB), are provided with which the at least one three-dimensional green body (GB) is treated at a temperature (T1)<140° C. in the presence of an inert gas. The present invention further relates to a three-dimensional brown body (BB) prepared by this process and to a three-dimensional sintered body (SB) prepared from the three-dimensional brown body (BB). Furthermore, the present invention relates to an apparatus, in which this process is carried out.

A task often encountered in recent times is the production of prototypes, spare parts and models of metallic or ceramic bodies, in particular, of prototypes, spare parts and models exhibiting complex geometries. Especially for the production of prototypes, a rapid production process is necessary. For this so called “rapid prototyping”, different processes are known. One of the most economical is the fused filament fabrication process (FFF), also known as “fused deposition modeling” (FDM).

The fused filament fabrication process (FFF) is an additive manufacturing technology. A three-dimensional object is produced by extruding a thermoplastic material through a nozzle to form layers as the thermoplastic material hardens after extrusion. The nozzle is heated to heat the thermoplastic material past its melting and/or glass transition temperature and is then deposited by the extrusion head on a base to form the three-dimensional object in a layer-wise fashion. The thermoplastic material is typically selected and its temperature is controlled so that it solidifies substantially immediately upon extrusion or dispensing onto the base with the build-up of multiple layers to form the desired three-dimensional object.

In order to form each layer, drive motors are provided to move the base and/or the extrusion nozzle (dispending head) relative to each other in a predetermined pattern along the x-, y- and z-axis. The FFF-process was first described in U.S. Pat. No. 5,121,329.

Typical materials for the production of three-dimensional objects are thermoplastic materials. The production of three-dimensional metallic or ceramic objects by fused filament fabrication is only possible if the metal or ceramic material has a low melting point so that it can be heated and melted by the nozzle. If the metal or ceramic material has a high melting point, it is necessary to provide the metal or ceramic material in a binder composition to the extrusion nozzle. The binder composition usually comprises a thermoplastic material. When depositing the mixture of a metal or ceramic material in a binder on a base, the formed three-dimensional object is a so called “green body”, which comprises the metal or ceramic material in a binder. To receive the desired metallic or ceramic object, the binder has to be removed and finally the object has to be sintered. The three-dimensional object which is formed after removing the binder is a so-called “brown body”; the three-dimensional object which is formed after sintering is a so-called “sintered body”. The removing of the binder is also called “debinding”.

For injection molded three-dimensional green bodies, said debinding process can be performed catalytically, chemically, with solvent extraction or thermally. Industrially, the catalytic debinding is favoured, preferably carried out with gaseous nitric acid, since this process is to be known to be the fastest debinding process. The acid acts as a catalyst and enables a fast and fully gas phase depolymerization of the thermoplastic binder.

However, working with concentrated nitric acid involves a significant safety effort and may only be carried out by trained specialist personnel. The risk of injury and increased damage to people and the environment in the event of incorrect handling can have drastic consequences.

Further, nitric acid reacts with many inorganic materials and therefore adversely change the chemical composition of the resulting brown or sintered body, respectively. Additionally, nitric acid decomposes during the debinding process and needs to be extracted from the system reducing the effective concentration of the catalyst and, therefore, making a constant dosing of the acid necessary leading to higher material consumption during the process. Furthermore, the highly corrosive nature of the acid makes it imperative to use technically sophisticated components and to monitor them continuously.

In order to avoid concentrated nitric acid, for debinding green bodies comprising polyoxymethylene (POM) feedstocks, oxalic acid as solution or as sublimed powder is suggested in the state of the art.

WO 2015/185468 A1 describes a process for the production of sintered bodies which comprises: molding a mixture comprising a sinterable metallic powder and polyoxymethylene or a copolymer containing a majority of oxymethylene units as binder to give a green body, removing the binder from the green body by treatment with a gaseous or liquid acid to obtain a brown part, and sintering the brown part, wherein the acid is selected from methanesulfonic acid or a solution of methanesulfonic acid, oxalic acid or mixtures thereof in a solvent, selected from water, C₁₋₄-carboxylic acids and mixtures thereof.

WO 2011/120066 A1 describes a method for producing shaped bodies based on aluminium alloys by metal powder injection moulding, comprising the following steps: a) preparing a feedstock by blending the metals contained in the desired alloy in the form of metal powders and/or one or more metal alloy powders with a binder; b) preparing a green body by injection moulding the feedstock; c) preparing a brown body by at least partially removing the binder from the green body by catalytic and/or solvent and/or thermal debinding; d) sintering the at least partially de-bindered brown body to obtain the desired shaped body. In step c) the binder is removed completely, wherein, optionally after carrying out one or more preceding de-binding stages, a thermal debinding in order to remove the (residual) binder is effected and is carried out in an atmosphere containing at least 0.5% by volume of oxygen, after which the resulting completely de-bindered brown body is sintered.

WO 94/25205 A1 describes the production of sintered articles by forming a mixture of a sinterable ceramic or metal powder plus polyoxymethylene or a copolymer containing predominant proportions of oxymethylene units as binder to give a green body, removing the binder by treatment with a gaseous acid and sintering. In order to remove the binder, an acid, like anhydrous oxalic acid or oxalic acid dehydrate, is used which is a solid at room temperature and sublimes or melts and evaporates at higher temperatures.

U.S. Pat. No. 5,695,697 A discloses a process for the producing of shaped sintered articles by first shaping a) a mixture of a ceramic or metallic powder or mixtures thereof with a moldable thermoplastic composition containing b) a thermoplastic polyoxymethylene binder and c) a second moldable and essentially inert thermoplastic polymer having a melting point between 90° and 220° C., such as a polyether of bisphenol A and an aliphatic diol. The binder is then removed from the shaped article by exposure to a gaseous acid-containing atmosphere, preferably below its softening temperature, while the second inert thermoplastic polymer is retained as a source of elemental carbon in which the ceramic or metallic powder is finely dispersed.

US 2016/0024293 A1 discloses a process for the production of a three-dimensional green body by a fused filament fabrication process comprising: heating a mixture (M) to a temperature (T_{M}), and depositing the mixture (M) into a build chamber using a layer-based additive technique to form the three-dimensional green body, wherein the mixture (M) comprises: (a) from 40 to 70% by volume of an inorganic powder (IP) based on the total volume of the mixture (M), and (b) from 30 to 60% by volume based on the total volume of the mixture (M) of a binder (B), wherein the binder (B) comprises at least one polyoxymethylene (POM). The removing of the binder (B) can comprise removal by an acidic treatment.

CN 106270506 A discloses a catalytic debinding furnace taking oxalic acid as a catalyst and a catalytic debinding method.

US 2013/0101456 A1 discloses a method for producing molded articles based on aluminum alloys by metal injection molding.

However, in the above-described debinding processes of the state of the art comprising oxalic acid, a debinding temperature of 140° C. is suggested by using an excess of anhydrous oxalic acid. While those conditions do not pose any problem to the debinding of injection molded or extruded three-dimensional bodies, said conditions are problematic for 3D-printed bodies, since the 3D-printed bodies tend to warp or distort during the debinding process at such temperatures. Further, heating at 140° C. is also disadvantageous from the commercial perspective. Moreover, the use of an excess of oxalic acid constitutes waste and poses potential hazard issues to the operators of the debinding equipment. Another issue is the time needed for debinding. According to examples 5 to 10 of WO 2011/120066 A1, the debinding time is 24 h, which is unattractive from a commercial perspective.

Therefore, the object underlying the present invention is to provide an improved process for the treatment of a three-dimensional green body which does not have the above-mentioned disadvantages of the prior art or has them only to a significantly reduced extend.

This object is achieved by the process for the treatment of at least one three-dimensional green body (GB) comprising at least the following steps
a) providing the at least one three-dimensional green body (GB), wherein the at least one three-dimensional green body (GB) comprises an inorganic powder (IP) and a binder (B), wherein the binder (B) comprises
   (b1) at least one polyoxymethylene (POM),
b) providing 0.01 to 5.0% by weight of anhydrous oxalic acid, based on the total weight of the at least one three-dimensional green body (GB), and
c) treating the at least one three-dimensional green body (GB) with the anhydrous oxalic acid at a temperature (T1)<140° C. in the presence of an inert gas.

It has surprisingly been found that by the inventive process, especially by using a temperature (T1)<140° C., which is lower than the sublimation temperature of the anhydrous oxalic acid, no warpage, or distortion, of the resulting brown and sintered bodies, respectively, are observed. Additionally, by using a temperature (T1)<140° C., preferably <135° C., more preferably <130° C., the debinding speed is advantageously in the range of 1 mm up to 2 mm per hour.

Further, by using 0.01 to 5.0% by weight, preferably 0.05 to 2.5% by weight, more preferably 0.1 to 1.5% by weight, of anhydrous oxalic acid, based on the total weight of the at least one three-dimensional green body (GB), the use of an excess of anhydrous oxalic acid, and therefore, waste and potential hazard issues to the operators of the debinding equipment, are avoided.

It has also, surprisingly, been found that the debinding process according to steps a) to c) and the sintering process according to step d) can be carried out in the same heating chamber (HC). This enables a seamless single step process flow.

In summary, by the inventive process, the overall effectiveness of a process for the production of a sintered part is improved, the risk of part and operator damages is reduced, and, as no additional heating and cooling times are needed and the parts are not transported from a debinding equipment into a sintering equipment, the production of the sintered part is faster.

For the purpose of the present invention, the term “three-dimensional green body” refers to a three-dimensional body comprising an inorganic powder (IP) and a binder (B), wherein the binder (B) comprises (b1) at least one polyoxymethylene (POM). The three-dimensional green body can be prepared by various processes, for example by an additive manufacturing process such as a fused filament fabrication process or by injection moulding. The processes for the production of the three-dimensional green body have in common that a mixture, which comprises the inorganic powder and the binder, and which is initially present in the solid state, is heat melted and thereafter cooled, wherein during the cooling the three-dimensional green body is formed. For the purpose of the present invention, the three-dimensional green body is preferably prepared by a fused filament fabrication process.

The present invention therefore also provides a process in which the at least one three-dimensional green body (GB) is prepared by injection molding or a fused filament fabrication process, preferably by a fused filament fabrication process.

The term “at least one three-dimensional green body” according to the present invention means precisely one three-dimensional green body and mixtures of two or more three-dimensional green bodies.

The invention is specified in more detail as follows.

The process for the treatment of the at least one three-dimensional green body (GB) according to the present invention comprises at least steps a) to c).

Steps a) and b) can be carried out at the same time, but it is also possible that step a) is carried out before step b) or that step b) is carried out before step a). Step c) is preferably carried out after steps a) and b).

### Step a)

In step a), the at least one three-dimensional green body (GB) is provided. The at least one three-dimensional green body (GB) comprises an inorganic powder (IP) and a binder (B), wherein the binder (B) comprises
(b1) at least one polyoxymethylene (POM).

Preferably, the at least one three-dimensional green body (GB) comprises from 30 to 70% by volume of the inorganic powder (IP) and from 30 to 70% by volume of the binder (B), based on the total volume of the at least one three-dimensional green body (GB), where the % by volume of the inorganic powder (IP) and the binder (B) generally add up to 100%.

More preferably, the at least one three-dimensional green body (GB) comprises from 45 to 65% by volume of the inorganic powder (IP) and from 35 to 55% by volume of the binder (B), based on the total volume of the at least one three-dimensional green body (GB), where the % by volume of the inorganic powder (IP) and the binder (B) generally add up to 100%.

Particularly preferably, the at least one three-dimensional green body (GB) comprises from 48 to 60% by volume of the inorganic powder (IP) and from 40 to 52% by volume of the binder (B), based on the total volume of the at least one three-dimensional green body (GB), where the % by volume of the inorganic powder (IP) and the binder (B) generally add up to 100%.

In one embodiment of the present invention, the at least one three-dimensional green body (GB) comprises at least one dispersant. Preferably, the at least one three-dimensional green body (GB) comprises from 0.1 to 5% by volume of the at least one dispersant, particularly preferably from 0.2 to 4% by volume of the at least one dispersant and most preferably from 0.5 to 2% by volume of the at least one dispersant, based on the total volume of the at least one three-dimensional green body (GB).

To the person skilled in the art it is clear that if the at least one three-dimensional green body (GB) comprises at least one dispersant, the % by volume of the inorganic powder (IP), the binder (B) and the at least one dispersant generally add up to 100%.

“At least one dispersant” according to the present invention means precisely one dispersant and, also, mixtures of two or more dispersants.

Examples for suitable dispersants are oligomeric polyethylene oxide having a low molecular weight of from 200 to 600 g/mol stearic acid, stearamides, hydroxystearic acids, fatty alcohols, fatty alcohol, fatty acid esters, sulfonates and block copolymers of ethylene oxide and propylene oxide and also, particularly preferably, polyisobutylene.

The components of the at least one three-dimensional green body (GB) are presented in more detail below.

### Inorganic Powder (IP)

The at least one three-dimensional green body (GB) comprises an inorganic powder (IP).

As inorganic powder (IP), any known inorganic powder (IP) can be used. Preferably, a sinterable inorganic powder (IP) is used. More preferably, the inorganic powder (IP) is a powder of at least one inorganic material selected from the group consisting of a metal, a metal alloy and a ceramic material, most preferably the inorganic powder (IP) is a metal or a metal alloy, particularly preferably, the inorganic powder (IP) is a metal.

The present invention therefore also provides a process in which the inorganic powder (IP) is a powder of at least one inorganic material selected from the group consisting of a metal, a metal alloy and a ceramic material, preferably the inorganic powder (IP) is a metal or a metal alloy, particularly preferably, the inorganic powder (IP) is a metal.

“An inorganic powder (IP)” means precisely one inorganic powder (IP) as well as a mixture of two or more inorganic powders (IP). The same holds true for the term “an inorganic material”. “An inorganic material” means precisely one inorganic material as well as mixtures of two or more inorganic materials. “A metal” means precisely one metal as well as mixtures of two or more metals. A metal within the present invention can be selected from any metal of the periodic table of the elements which is stable under the conditions of a fused filament fabrication process and which can form three-dimensional objects. Preferably, the metal is selected from the group consisting of aluminium, yttrium, titanium, zirconium, vanadium, niobium, chromium, molybdenum, tungsten, manganese, iron, carbonyl iron powder (CIP), cobalt, nickel, copper, silver, zinc, magnesium, tin and cadmium, more preferably, the metal is selected from the group consisting of titanium, niobium, chromium, molybdenum, tungsten, manganese, iron, carbonyl iron powder (CIP), nickel and copper. With particular preference, the metal is selected from the group consisting of titanium, iron and carbonyl iron powder (CIP).

Carbonyl iron powder (CIP) is highly pure iron powder, prepared by chemical decomposition of purified iron pentacarbonyl.

“A metal alloy” means precisely one metal alloy as well as mixtures of two or more metal alloys. Within the context of the present invention, the term “metal alloy” means a solid solution or a partial solid solution, which exhibits metallic properties and comprises a metal and another element. “A metal” means, as stated above precisely one metal and also mixtures of two or more metals. The same applies to “another element”. “Another element” means precisely one other element and also mixtures of two or more other elements. Solid solution metal alloys exhibit a single solid phase microstructure while partial solid solution metal alloys exhibit two or more solid phases. These two or more solid phases can be homogeneous distributed in the metal alloy, but they can also be heterogeneous distributed in the metal alloy. The metal alloys can be prepared according to any process known to the person skilled in the art. For example, the metal can be melted and the other element can be added to the molten metal. However, it is also possible that the inorganic powder (IP) comprises the metal and the other element without the preparation of a metal alloy before. The metal alloy will then be formed during the process of the preparation of the three-dimensional object.

Concerning the metal, the above-stated embodiments and preferences for the metal apply. The other element can be selected from the metals described above. However, the other element differs from the metal comprised in the metal alloy. The other element can be selected from any element of the periodic table, which forms a metal alloy that is stable under the conditions of a fused filament fabrication process or, which is stable or forms stable alloys with the metal under the conditions of a fused filament process. In a preferred embodiment of the present invention the other element is selected from the group consisting of the aforementioned metals, boron, carbon, silicon, phosphorous, sulfur, selenium and tellurium. Particularly preferably, the at least one other element is selected from the group consisting of the aforementioned metals, boron, carbon, silicon, phosphorous and sulfur. Preferably, the metal alloy according to the present invention comprises steel.

“A ceramic material” means precisely one ceramic material as well as mixtures of two or more ceramic materials. In the context of the present invention, the term “ceramic material” means a non-metallic compound of a metal or a first metalloid, and a non-metal or a second metalloid.

“A metal” means precisely one metal and also mixtures of two or more metals. The same relies to “a non-metal” and “a first metalloid”, as well as “a second metalloid”. “A non-metal”means precisely one non-metal and also mixtures of two or more non-metals. “A first metalloid” means precisely one first metalloid and also mixtures of two or more first metalloids. “A second metalloid” means precisely one second metalloid and also mixtures of two or more second metalloids.

Non-metals are known per se to the person skilled in the art. The non-metal according to the present invention can be selected from any non-metal of the periodic table. Preferably, the at least one non-metal is selected from the group consisting of carbon, nitrogen, oxygen, phosphorus and sulfur.

Metalloids are as well known per se to the skilled person. The first metalloid and the second metalloid can be selected from any metalloid of the periodic table. Preferably, the first metalloid and/or the second metalloid are selected from the group consisting of boron and silicon. It should be clear that the first metalloid and the second metalloid differ from each other. For example, if the first metalloid is boron, then the second metalloid is selected from any other metalloid of the periodic table of the elements besides boron.

In one embodiment of the present invention, the ceramic material is selected from the group consisting of oxides, carbides, borides, nitrides and silicides. In a preferred embodiment the ceramic material is selected from the group consisting of MgO, CaO, SiO₂, Na₂O, Al₂O₃, ZrO₂, Y₂O₃, SiC, Si₃N₄, TiB and AlN. Particularly preferred, the ceramic material is selected from the group consisting of Al₂O₃, ZrO₂ and Y₂O₃.

For the preparation of the inorganic powder (IP), the inorganic material has to be pulverized. To pulverize the inorganic material, any method known to the person skilled in the art can be used. For example, the inorganic material can be ground. The grinding for example can take place in a classifier mill, in a hammer mill or in a ball bill.

The carbonyl iron powder (CIP) is prepared by chemical decomposition of purified iron pentacarbonyl.

The particle sizes of the inorganic powders (IP) used are preferably from 0.1 to 80 μm, particularly preferably from 0.5 to 50 μm, more preferably from 0.1 to 30 μm, measured by laser diffraction.

The present invention therefore also provides a process in which the particle size of the inorganic powder (IP) is from 0.1 to 80 μm.

### Binder (B)

The at least one three-dimensional green body (GB) also comprises a binder (B), wherein the binder (B) comprises
(b1) at least one polyoxymethylene (POM).

Preferably, the binder (B) comprises
(b1) from 50 to 96% by weight of at least one polyoxymethylene (POM) based on the total weight of the binder (B),
(b2) from 2 to 35% by weight of at least one polyolefin (PO) based on the total weight of the binder (B),
(b3) from 2 to 40% by weight of at least one further polymer (FP) based on the total weight of the binder (B), where the % by weight of components (b1), (b2) and (b3) generally add up to 100%.

Therefore, the present invention also provides a process in which the binder (B) comprises
(b1) from 50 to 96% by weight of at least one polyoxymethylene (POM) based on the total weight of the binder (B),
(b2) from 2 to 35% by weight of at least one polyolefin (PO) based on the total weight of the binder (B),
(b3) from 2 to 40% by weight of at least one further polymer (FP) based on the total weight of the binder (B).

In a preferred embodiment, the binder (B) comprises
as component (b1) from 60 to 90% by weight of at least one polyoxymethylene (POM),
as component (b2) from 3 to 20% by weight of at least one polyolefin (PO) and
as component (b3) from 5 to 30% by weight of at least one further polymer (FP),
each based on the total weight of the binder (B), where the % by weight of components (b1), (b2) and (b3) usually add up to 100%.

Particularly preferred, the binder (B) comprises
as component (b1) from 70 to 85% by weight of at least one polyoxymethylene (POM),
as component (b2) from 4 to 15% by weight of at least one polyolefin (PO) and
as component (b3) from 10 to 26% by weight of at least one further polymer (FP),
each based on the total weight of the binder (B), where the % by weight of components (b1), (b2) and (b3) add up to 100%.

According to the present invention, component (b1) differs from component (b2), component (b2) differs from component (b3) and component (b3) differs from component (b1). However, component (b1), component (b2) and component (b3) can comprise identical building units and, for example, differ in a further building unit and/or differ in the molecular weight.

The components (b1), (b2) and (b3) of the binder (B) are described in more detail below.

Component (b1)/Polyoxymethylene (POM)

The terms “component (b1)” and “at least one polyoxymethylene (POM)” for the purpose of the present invention are synonymous and are used interchangeably throughout the present invention.

Preferably, the binder (B) comprises 50 to 96% by weight, more preferably 60 to 90% by weight, most preferably 70 to 85% by weight of the at least one polyoxymethylene (POM), based on the total weight of the binder (B).

“At least one polyoxymethylene (POM)” within the present invention means precisely one polyoxymethylene (POM) and also mixtures of two or more polyoxymethylenes (POM). For the purpose of the present invention, the term “polyoxymethylene (POM)” encompasses both, polyoxymethylene (POM) itself, i.e. polyoxymethylene (POM) homopolymers, and also polyoxymethylene (POM) copolymers and polyoxymethylene (POM) terpolymers. Polyoxymethylene (POM) homopolymers usually are prepared by polymerization of a monomer selected from a formaldehyde source (b1a). The term “formaldehyde source (b1a)” relates to substances which can liberate formaldehyde under the reaction conditions of the preparation of polyoxymethylene (POM). The formaldehyde sources (b1a) are advantageously selected from the group of cyclic or linear formals, in particular from the group consisting of formaldehyde and 1,3,5-trioxane. 1,3,5-trioxane is particularly preferred.

Polyoxymethylene (POM) copolymers are known per se and are commercially available. They are usually prepared by polymerization of trioxane as main monomer. In addition, comonomers are concomitantly used. The main monomers are preferably selected from among trioxane and other cyclic or linear formals or other formaldehyde sources (b1a).

The expression “main monomers” is intended to indicate that the proportion of these monomers in the total amount of monomers, i.e. the sum of main monomers and comonomers, is greater than the proportion of the comonomers in the total amount of monomers. Quite generally, polyoxymethylene (POM) according to the present invention has at least 50 mol-% of repeating units —CH₂O— in the main polymer chain. Suitable polyoxymethylene (POM) copolymers are in particular those which comprise the repeating units —CH₂O— and from 0.01 to 20 mol-%, in particular from 0.1 to 10 mol-% and very particularly preferably from 0.5 to 6 mol-% of repeating units of the formula (I),

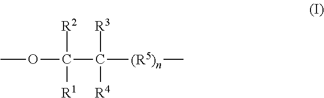

wherein
R¹ to R⁴ are each independently of one another selected from the group consisting of H, C₁-C₄-alkyl and halogen-substituted C₁-C₄-alkyl;
R⁵ is selected from the group consisting of a chemical bond, a (—CR^{5a}R^{5b}—) group and a (—CR^{5a}R^{5b}O—) group,
wherein
R^{5a} and R^{5b} are each independently of one another selected from the group consisting of H and unsubstituted or at least monosubstituted C₁-C₄-alkyl,
   wherein the substituents are selected from the group consisting of F, Cl, Br, OH and C₁-C₄-alkyl;
n is 0, 1, 2 or 3.

If n is 0, then R⁵ is a chemical bond between the adjacent carbon atom and the oxygen atom. If R⁵ is a (—CR^{5a}R^{5b}O—) group, then the oxygen atom (O) of the (—CR^{5a}R^{5b}O—) group is bound to another carbon atom (C) of formula (I) and not to the oxygen atom (O) of formula (I). In other words, formula (I) does not comprise peroxide compounds. The same holds true for formula (II).

Within the context of the present invention, definitions such as C₁-C₄-alkyl, as for example defined above for the radicals R¹ to R⁴ in formula (I), mean that this substituent (radical) is an alkyl radical with a carbon atom number from 1 to 4. The alkyl radical may be linear or branched and also optionally cyclic. Alkyl radicals which have both a cyclic component and also a linear component likewise fall under this definition. Examples of alkyl radicals are methyl, ethyl, n-propyl, iso-propyl, butyl, iso-butyl, sec-butyl and tert-butyl.

In the context of the present invention, definitions, such as halogen-substituted C₁-C₄-alkyls, as for example defined above for the radicals R¹ to R⁴ in formula (I), mean that the C₁-C₄-alkyl is substituted by at least one halogen. Halogens are F (fluorine), Cl (chlorine), Br (bromine) and I (iodine).

The repeating units of formula (I) can advantageously be introduced into the polyoxymethylene (POM) copolymers by ring-opening of cyclic ethers as first comonomers (b1b). Preference is given to first comonomers (b1b) of the general formula (II),

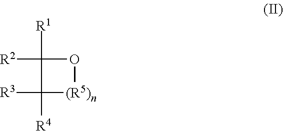

wherein
R¹ to R⁵ and n have the meanings as defined above for the general formula (I).

As first comonomers (b1b) mention may be made for example of ethylene oxide, 1,2-propylene oxide, 1,2-butylene oxide, 1,3-butylene oxide, 1,3-dioxane, 1,3-dioxolane and 1,3-dioxepane (=butanediol formal, BUFO) as cyclic ethers and also linear oligoformals or polyformals such as polydioxolane or polydioxepane. 1,3-dioxolane and 1,3-dioxepane are particularly preferred first comonomers (b1b), very particular preferred is 1,3-dioxepane as first comonomer (b1b).

Polyoxymethylene (POM) polymers which can be obtained by reaction of a formaldehyde source together with the first comonomer (b1b) and a second comonomer (b1c) are likewise suitable. The addition of the second comonomer (b1c) makes it possible to prepare, in particular, polyoxymethylene (POM) terpolymers.

The second comonomer (b1c) is preferably selected from the group consisting of a compound of formula (III) and a compound of formula (IV),

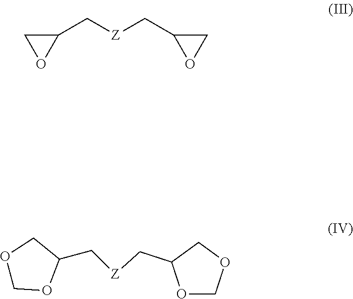

wherein
Z is selected from the group consisting of a chemical bond, an (—O—) group and an (—O—R⁶—O—) group,
wherein
R⁶ is selected from the group consisting of unsubstituted C₁-C₈-alkylene and C₃-C₈-cycloalkylene.

Within the context of the present invention, definitions such as C₁-C₈-alkylene means C₁-C₈-alkanediyle. The C₁-C₈-alkylene is a hydrocarbon having two free valences and a carbon atom number of from 1 to 8. The C₁-C₈-alkylene according to the present invention can be branched or unbranched.

Within the context of the present invention, definitions such as C₃-C₈-cycloalkylene means C₃-C₈-cycloalkanediyle. A C₃-C₈-cycloalkylene is a cyclic hydrocarbon having two free valences and a carbon atom number of from 3 to 8. Hydrocarbons having two free valences, a cyclic and also a linear component, and a carbon atom number of from 3 to 8 likewise fall under this definition.

Preferred examples of the second comonomer (b1c) are ethylene diglycidyl, diglycidyl ether and diethers prepared from glycidyl compounds and formaldehyde, dioxane or trioxane in a molar ratio of 2:1 and likewise diethers prepared from 2 mol of a glycidyl compound and 1 mol of an aliphatic diol having from 2 to 8 carbon atoms, for example the diglycidyl ether of ethylene glycol, 1,4-butanediol, 1,3-butanediol, 1,3-cyclobutanediol, 1,2-propanediol and 1,4-cyclohexanediol.

In a preferred embodiment, component (b1) is a polyoxymethylene (POM) copolymer which is prepared by polymerization of from at least 50 mol-% of a formaldehyde source, from 0.01 to 20 mol-% of at least one first comonomer (b1b) and from 0 to 20 mol-% of at least one second comonomer (b1c).

In a particularly preferred embodiment, component (b1) is a polyoxymethylene (POM) copolymer which is prepared by polymerization of from 80 to 99.98 mol-%, preferably from 88 to 99 mol-% of a formaldehyde source, from 0.1 to 10 mol-%, preferably from 0.5 to 6 mol-% of at least one first comonomer (b1b) and from 0.1 to 10 mol-%, preferably from 0.5 to 6 mol-% of at least one second comonomer (b1c).

In a further preferred embodiment, component (b1) is a polyoxymethylene (POM) copolymer which is prepared by polymerization of from at least 50 mol-% of a formaldehyde source, from 0.01 to 20 mol-% of at least one first comonomer (b1b) of the general formula (II) and from 0 to 20 mol-% of at least one second comonomer (b1c) selected from the group consisting of a compound of formula (III) and a compound of formula (IV).

Another subject of the present invention is therefore a process, wherein component (b1) is a polyoxymethylene (POM) copolymer which is prepared by polymerization of
from at least 50 mol-% of a formaldehyde source (b1a),
from 0.01 to 20 mol-% of at least one first comonomer (b1b) of the general formula (II)

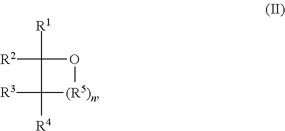

wherein
R¹ to R⁴ are each independently of one another selected from the group consisting of H, C₁-C₄-alkyl and halogen-substituted C₁-C₄-alkyl;
R⁵ is selected from the group consisting of a chemical bond, a (—CR^{5a}R^{5b}—) group and a (—CR^{5a}R^{5b}O—) group,
wherein
R^{5a} and R^{5b} are each independently of one another selected from the group consisting of H and unsubstituted or at least monosubstituted C₁-C₄-alkyl,
wherein the substituents are selected from the group consisting of F, Cl, Br, OH and C₁-C₄-alkyl;
n is 0, 1, 2 or 3;
and
from 0 to 20 mol-% of at least one second comonomer (b1c) selected from the group consisting of a compound of formula (III) and a compound of formula (IV)

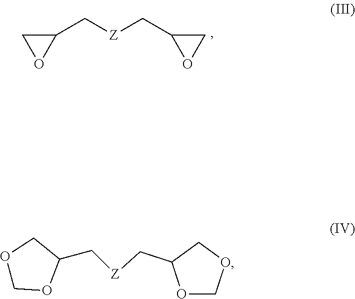

wherein
Z is selected from the group consisting of a chemical bond, an (—O—) group and an (—O—R⁶—O—) group,
wherein

R⁶ is selected from the group consisting of unsubstituted C₁-C₈-alkylene and C₃-C₈-cycloalkylene.

In a preferred embodiment of the present invention, at least some of the OH-end groups of the polyoxymethylene (POM) are capped. Methods for capping OH-end groups are known to the skilled person. For example, the OH-end groups can be capped by etherification or esterification.

Preferred polyoxymethylene (POM) copolymers have melting points of at least 150° C. and weight average molecular weights M_{w} in the range from 5 000 g/mol to 300 000 g/mol, preferably from 6 000 g/mol to 150 000 g/mol, particularly preferably in the range from 7 000 g/mol to 100 000 g/mol.

Particular preference is given to polyoxymethylene (POM) copolymers having a polydispersity (M_{w}/Mₙ) of from 2 to 15, preferably from 2.5 to 12, particularly preferably from 3 to 9.

The measurement of the weight average molecular weight (M_{w}) and the number average molecular weight (Mₙ) is generally carried out by gel permeation chromatography (GPC). GPC is also known as sized exclusion chromatography (SEC).

Methods for the preparation of polyoxymethylene (POM) are known to those skilled in the art.

Component (b2)/Polyolefin (PO)

Further, the binder (B) may comprise a component (b2).

Preferably, the binder (B) comprises from 2 to 35% by weight, more preferably from 3 to 20% by weight, most preferably from 4 to 15% by weight of component (b2).

Preferably component (b2) is at least one polyolefin (PO). “At least one polyolefin (PO)” within the present invention means precisely one polyolefin (PO) and also mixtures of two or more polyolefins (PO).

Polyolefins (PO) are known per se and are commercially available. They are usually prepared by polymerization of C₂-C₈-alkene monomers, preferably by polymerization of C₂-C₄-alkene monomers.

Within the context of the present invention, C₂-C₈-alkene means unsubstituted or at least monosubstituted hydrocarbons having 2 to 8 carbon atoms and at least one carbon-carbon double bond (C—C-double bond). “At least one carbon-carbon double bond” means precisely one carbon-carbon double bond and also two or more carbon-carbon double bonds.

In other words, C₂-C₈-alkene means that the hydrocarbons having 2 to 8 carbon atoms are unsaturated. The hydrocarbons may be branched or unbranched. Examples for C₂-C₈-alkenes with one C—C-double bond are ethene, propene, 1-butene, 2-butene, 2-methyl-propene (=isobutylene), 1-pentene, 2-pentene, 2-methyl-1-butene, 3-methyl-1-butene, 1-hexene, 2-hexene, 3-hexene and 4-methyl-1-pentene. Examples for C₂-C₈-alkenes having two or more C—C-double bonds are allene, 1,3-butadiene, 1,4-pentadiene, 1,3-pentadiene, 2-methyl-1,3-butadiene (=isoprene).

If the C₂-C₈-alkenes have one C—C-double bond, the polyolefins (PO) prepared from those monomers are linear. If more than one double bond is present in the C₂-C₈-alkenes, the polyolefins (PO) prepared from those monomers can be crosslinked. Linear polyolefins (PO) are preferred.

It is also possible to use polyolefin (PO) copolymers, which are prepared by using different C₂-C₈-alkene monomers during the preparation of the polyolefins (PO).

Preferably, the polyolefins (PO) are selected from the group consisting of polymethylpentene, poly-1-butene, polyisobutylene, polyethylene and polypropylene. Particular preference is given to polyethylene and polypropylene and also their copolymers as are known to those skilled in the art and are commercially available.

The polyolefins (PO) can be prepared by any polymerization process known to the skilled person, preferably by free radical polymerization, for example by emulsion, bead, solution or bulk polymerization. Possible initiators are, depending on the monomers and the type of polymerization, free radical initiators such as peroxy compounds and azo compounds with the amounts of initiator generally being in the range from 0.001 to 0.5% by weight, based on the monomers.

Component (b3)/Further Polymer (FP)

The binder (B) may comprise a further polymer (FP) as component (b3).

The terms “component (b3)” and “further polymer (FP)” for the purpose of the present invention are synonymous and are used interchangeably throughout the present invention.

Preferably, the binder (B) comprises 2 to 40% by weight, more preferably 5 to 30% by weight, most preferably 10 to 26% by weight, based on the total weight of the binder (B), as component (b3).

Component (b3) according to the present invention is at least one further polymer (FP). “At least one further polymer (FP)” within the present invention means precisely one further polymer (FP) and also mixtures of two or more further polymers (FP).

As already stated above, the at least one further polymer (FP) differs from component (b1), the polyoxymethylene (POM), and component (b2), the polyolefin (PO).

According to the present invention, the at least one further polymer (FP) is preferably selected from the group consisting of a polyether, a polyurethane, a polyepoxide, a polyamide, a vinyl aromatic polymer, a poly(vinyl ester), a poly(vinyl ether), a poly(alkyl(meth)acrylate) and copolymers thereof.

Another subject of the present invention is therefore a process, wherein the further polymer (FP) is at least one further polymer (FP) selected from the group consisting of a polyether, a polyurethane, a polyepoxide, a polyamide, a vinyl aromatic polymer, a poly(vinyl ester), a poly(vinyl ether), a poly(alkyl(meth)acrylate) and copolymers thereof.

Preferably, component (b3), the at least one further polymer (FP), is selected from the group consisting of a poly(C₂-C₆-alkylene oxide), an aliphatic polyurethane, an aliphatic uncrosslinked epoxide, an aliphatic polyamide, a vinyl aromatic polymer, a poly(vinyl ester) of an aliphatic C₁-C₈ carboxylic acid, a poly(vinyl ether) of a C₁-C₈ alkyl vinyl ether, a poly(alkyl(meth)acrylate) of a C₁₋₈-alkyl and copolymers thereof.

Preferred at least one further polymers (FP) are described in more detail below.

Polyethers comprise repeating units of formula (V).

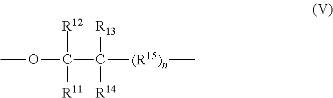

wherein
R¹¹ to R¹⁴ are each independently of one another selected from the group consisting of H, C₁-C₄-alkyl and halogen-substituted C₁-C₄-alkyl;
R¹⁵ is selected from the group consisting of a chemical bond, a (—CR^{15a}R^{15b}—) group and a (—CR^{15a}R^{15b}O—) group,
wherein
R^{15a} and R^{15b} are each independently of one another selected from the group consisting of H and unsubstituted or at least monosubstituted C₁-C₄-alkyl,
   wherein the substituents are selected from the group consisting of F, Cl, Br, OH and C₁-C₄-alkyl;
n is 0, 1, 2 or 3.

If n is 0, then R¹⁵ is a chemical bond between the adjacent carbon atom and the oxygen atom. If R¹⁵ is a (—CR^{15a}R^{15b}O—) group, then the oxygen atom (O) of the (—CR^{15a}R^{15b}O—) group is bound to another carbon atom (C) of formula (V) and not to the oxygen atom (O) of formula (V). In other words, formula (V) does not comprise peroxide compounds. The same holds true for formula (VI).

Typical polyethers as well as their preparation are known to the skilled person.

A preferred polyether according to the present invention is, for example, a poly(alkylene glycol), also known as a poly(alkylene oxide).

Polyalkylene oxides and their preparation are known to the skilled person. They are usually synthesized by interaction of water and a bi- or polyvalent alcohol with cyclic ethers, i.e. alkylene oxides, of the general formula (VI). The reaction is catalyzed by an acidic or basic catalyst. The reaction is a so-called ring-opening polymerization of the cyclic ether of the general formula (VI)

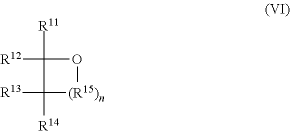

wherein
R¹¹ to R¹⁵ have the same meanings as defined above for formula (V).

A preferred poly(alkylene oxide) according to the present invention is derived from monomers of the general formula (VI) having 2 to 6 carbon atoms in the ring. In other words, preferably, the poly(alkylene oxide) is a poly(C₂-C₆-alkylene oxide). Particular preference is given to a poly(alkylene oxide) derived from monomers selected from the group consisting of 1,3-dioxolane, 1,3-dioxepane and tetrahydrofuran (IUPAC-name: oxolane). In other words, particularly preferably, the poly(alkylene oxide) is selected from the group consisting of poly-1,3-dioxolane, poly-1,3-dioxepane and polytetrahydrofuran.

In one embodiment, the poly(alkylene oxide) can comprise OH-end groups. In another embodiment, at least some of the OH-end groups of the poly(alkylene oxide) can be capped. Methods for capping OH-end groups are known to the skilled person. For example, the OH-end groups can be capped by etherification or esterification.

The weight average molecular weight of the poly(alkylene oxide) is preferably in the range of from 1 000 to 150 000 g/mol, particular preferably from 1 500 to 120 000 g/mol and more preferably in the range of from 2 000 to 100 000 g/mol.

A polyurethane is a polymer having carbamate units. Polyurethanes as well as their preparation is known to the skilled person.

Within the present invention, aliphatic polyurethanes are preferred. They can, for example, be prepared by polyaddition of aliphatic polyisocyanates and aliphatic polyhydroxy compounds. Among the polyisocyanates, diisocyanates of the general formula (VII) are preferred

OCN—R⁷—NCO (VII),
wherein

R⁷ is a substituted or unsubstituted C₁-C₂₀-alkylene or C₄-C₂₀-cycloalkylene, wherein the substituents are selected from the group consisting of F, Cl, Br and C₁-C₆-alkyl.

Preferably R⁷ is a substituted or unsubstituted C₂-C₁₂-alkylene or C₆-C₁₅-cycloalkylene.

Within the context of the present invention, definitions such as C₁-C₂₀-alkylene means C₁-C₂₀-alkanediyle. The C₁-C₂₀-alkylene is a hydrocarbon having two free valences and a carbon atom number of from 1 to 20. The C₁-C₂₀-alkylene according to the present invention can be branched or unbranched.

Within the context of the present invention, definitions such as C₄-C₂₀-cycloalkylene means C₄-C₂₀-cycloalkanediyle. A C₄-C₂₀-cycloalkylene is a cyclic hydrocarbon having two free valences and a carbon atom number of from 4 to 20. Hydrocarbons having two free valences, a cyclic and also a linear component and a carbon atom number of from 4 to 20 likewise fall under this definition.

Preferred diisocyanates are selected from the group consisting of hexamethylenediisocyanate, 2,2,4-trimethyl hexamethylenediisocyanate, 2,4,4-trimethyl hexamethylenediisocyanate, 1,2-diisocyanatomethyl cyclohexane, 1,4-diisocyanatomethyl cyclohexane and isophorondiisocyanate (IUPAC-name: 5-iso-cyanato-1-(isocyanatomethyl)-1,3,3-trimethyl-cyclohexane).

The diisocyanates may also be used in oligomeric, for example dimeric or trimeric form. Instead of the polyisocyanates, it is also possible to use conventional blocked polyisocyanates which are obtained from the stated isocyanates, for example, by an addition reaction of phenol or caprolactam.

Suitable polyhydroxy compounds for the preparation of aliphatic polyurethanes are, for example, polyesters, polyethers, polyesteramides or polyacetales or mixtures thereof.

Suitable chain extenders for the preparation of the polyurethanes are low molecular weight polyols, in particular diols and polyamines, in particular diamines or water.

The polyurethanes are preferably thermoplastic and therefore preferably essentially uncrosslinked, i.e. they can be melted repeatedly without significant signs of decomposition. Their reduced specific viscosities are as a rule from 0.5 to 3 dL/g, preferably from 1 to 2 dL/g measured at 30° C. in dimethylformamide.

A polyepoxide comprises at least two epoxide groups. The epoxide groups are also known as glycidyl or oxirane groups. “At least two epoxide groups” mean precisely two epoxide groups and also three or more epoxide groups.

Polyepoxides and their preparation are known to the person skilled in the art. For example, polyepoxides are prepared by the reaction of epichlorhydrine (IUPAC-name: chlormethyloxirane) and a diol, a polyol or a dicarboxylic acid. Polyepoxides prepared in this way are polyethers having epoxide end groups.

Another possibility to prepare polyepoxides is the reaction of glycidyl(meth)acrylate (IUPAC-name: oxiran-2-ylmethyl-2-methylprop-2-enoate) with polyolefins or polyacrylates. This results in polyolefins or polyacrylates having epoxy end groups.

Preferably, aliphatic uncrosslinked polyepoxides are used. Copolymers of epichlorhydrine and 2,2-bis-(4-hydroxyphenyl)-propane (bisphenol A) are particularly preferred.

Component (b3) (the at least one further polymer (FP)) can also comprise a polyamide. Aliphatic polyamides are preferred.

The intrinsic viscosity of suitable polyamides is generally from 150 to 350 mL/g, preferably from 180 to 275 mL/g. Intrinsic viscosity is determined here from a 0.5% by weight solution of the polyamide in 96% by weight sulfuric acid at 25° C. in accordance with ISO 307.

Preferred polyamides are semicrystalline or amorphous polyamides.

Examples of polyamides suitable as component (b3) are those that derive from lactams having from 7 to 13 ring members. Other suitable polyamides are those obtained through reaction of dicarboxylic acids with diamines.

Examples that may be mentioned of polyamides that derive from lactams are polyamides that derive from polycaprolactam, from polycaprylolactam, and/or from polylaurolactam.

If polyamides are used that are obtainable from dicarboxylic acids and diamines, dicarboxylic acids that can be used are alkanedicarboxylic acids having from 6 to 14 carbon atoms, preferably from 6 to 10 carbon atoms. Aromatic dicarboxylic acids are also suitable.

Examples that may be mentioned here as dicarboxylic acids are adipic acid, azelaic acid, sebacic acid, dodecanedicarboxylic acid, and also terephthalic acid and/or isophthalic acid.

Examples of suitable diamines are alkanediamines, having from 4 to 14 carbon atoms, in particular alkanediamines having from 6 to 8 carbon atoms, and also aromatic diamines, for example m-xylylenediamine, di(4-aminophenyl) methane, di(4-aminocyclohexyl) methane, 2,2-di(4-aminophenyl) propane, 2,2-di(4-aminocyclohexyl)-propane, and 1,5-diamino-2-methylpentane.

Other suitable polyamides are those obtainable through copolymerization of two or more of the monomers mentioned above and mentioned below, and mixtures of a plurality of polyamides in any desired mixing ratio.

Preferred polyamides are polyhexamethyleneadipamide, polyhexamethylene-sebacamide, and polycaprolactam, and also nylon-6/6,6, in particular having a proportion of from 75 to 95% by weight of caprolactam units.

Particular preference is given to mixtures of nylon-6 with other polyamides, in particular with nylon-6/6,6 (PA 6/66), particular preference being given to mixtures of from 80 to 50% by weight of PA 6 and from 20 to 50% by weight of PA 6/66, where the PA 6/66 comprises from 75 to 95% by weight of caprolactam units, based on the total weight of the PA 6/66 in the mixture.

The following, non-exclusive list comprises the abovementioned polyamides, and other suitable polyamides, and also the monomers comprised.

AB polymers:

| | |
|---|---|
| PA 4 | Pyrrolidone |
| PA 6 | ε-Caprolactam |
| PA 7 | Ethanolactam |
| PA 8 | Caprylolactam |
| PA 9 | 9-Aminopelargonic acid |
| PA 11 | 11-Aminoundecanoic acid |
| PA 12 | Laurolactam |

AA/BB polymers:

| | |
|---|---|
| PA 46 | Tetramethylenediamine, adipic acid |
| PA 66 | Hexamethylenediamine, adipic acid |
| PA 69 | Hexamethlyenediamine, azelaic acid |
| PA 610 | Hexamethylenediamine, sebacic acid |
| PA 612 | Hexamethylenediamine, decanedicarboxylic acid |
| PA 613 | Hexamethylenediamine, undecanedicarboxylic acid |
| PA 1212 | 1,12-Dodecanediamine, decanedicarboxylic acid |
| PA 1313 | 1,13-Diaminotridecane, undecanedicarboxylic acid |
| PA 6T | Hexamethylenediamine, terephthalic acid |
| PA MXD6 | m-Xylylenediamine, adipic acid |
| PA 6I | Hexamethylenediamine, isophthalic acid |
| PA 6-3-T | Trimethylhexamethylenediamine, terephthalic acid |
| PA 6/6T | (see PA 6 and PA 6T) |
| PA 6/66 | (see PA 6 and PA 66) |
| PA 6/12 | (see PA 6 and PA 12) |
| PA 66/6/610 | (see PA 66, PA 6 and PA 610) |
| PA 6I/6T | (see PA 6I and PA 6T) |
| PA PACM 6 | Diaminodicyclohexylmethane, adipic acid |
| PA PACM 12 | Diaminodicyclohexylmethane, laurolactam |
| PA 6I/6T/PACM | as PA 6I/6T + diaminodicyclohexylmethane |
| PA 12/MACMI | Laurolactam, dimethyldiaminodicyclohexylmethane, |
| | isophthalic acid |
| PA 12/MACMT | Laurolactam, dimethyldiaminodicyclohexylmethane, |
| | terephthalic acid |
| PA PDA-T | Phenylenediamine, terephthalic acid |

Preferred polyamides are PA 6, PA 66 and PA PACM 6.

Vinyl aromatic polymers are polyolefins having unsubstituted or at least monosubstituted styrene as monomer unit. Suitable substituents are, for example, C₁-C₆-alkyls, F, Cl, Br and OH. Preferred vinyl aromatic polymers are selected from the group consisting of polystyrene, poly-α-methylstyrene and copolymers thereof with up to 30% by weight of comonomers selected from the group consisting of acrylic esters, acrylonitrile and methacrylonitrile.

Vinyl aromatic polymers are commercially available and known to the person skilled in the art. The preparation of these polymers is also known to the person skilled in the art.

Preferably, the vinyl aromatic polymers are prepared by free radical polymerization, for example, by emulsion, bead, solution or bulk polymerization. Possible initiators are, depending on the monomers and the type of polymerization, free radical initiators such as peroxide compounds and azo compounds with the amounts of initiator generally being in the range from 0.001 to 0.5% by weight, based on the monomers.

Poly(vinyl esters) and their preparation are known to the skilled person. Poly(vinyl esters) are preferably prepared by polymerization of vinyl esters. In a preferred embodiment of the present invention, the vinyl esters are vinyl esters of aliphatic C₁-C₆ carboxylic acids. Preferred monomers are vinyl acetate and vinyl propionate. These monomers form poly(vinyl acetate) and poly(vinyl propionate) polymers.

Poly(vinyl ethers) are prepared by polymerization of vinyl ether monomers. Poly(vinyl ethers) and their preparation are known to the skilled person. In a preferred embodiment, the vinyl ethers are vinyl ethers of aliphatic C₁-C₈ alkyl ethers. Preferred monomers are methyl vinyl ether and ethyl vinyl ether, forming poly(methyl vinyl ether) and poly(ethyl vinyl ether) during the polymerization.

Preferably, the poly(vinyl ethers) are prepared by free radical polymerization, for example, by emulsion, bead, solution, suspension or bulk polymerization. Possible initiators are, depending on the monomers and the type of polymerization, free radical initiators such as peroxide compounds and azo compounds with the amounts of initiator generally being in the range from 0.001 to 0.5% by weight, based on the monomers.

Poly(alkyl(meth)acrylate) within the present invention comprises poly(alkyl acrylate), poly(alkyl methacrylates) and copolymers thereof. Poly(alkyl(meth)acrylate) comprises units derived from monomers of formula (VIII),

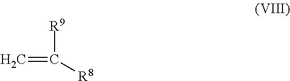

wherein
R⁸ is selected from the group consisting of H and C₁-C₈-alkyl and
R⁹ is a radical of formula (IX)

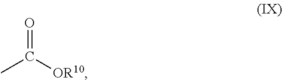

wherein
R¹⁰ is a C₁-C₁₄-alkyl.

Preferably, R⁸ is selected from the group consisting of H and C₁-C₄-alkyl, particularly preferably R⁸ is H or methyl. Preferably, R¹⁰ is a C₁-C₈-alkyl, particularly preferably, R¹⁰ is methyl or ethyl.

If R⁸ in formula (VIII) is H and R⁹ is a radical of formula (IX) and R¹⁰ in formula (IX) is methyl, then the monomer of formula (VIII) is methyl acrylate.

If R⁸ in formula (VIII) is H and R⁹ is a radical of formula (IX) and R¹⁰ in formula (IX) is ethyl, the monomer of formula (VIII) is ethyl acrylate.

If R⁸ in formula (VIII) is methyl and R⁹ is a radical of formula (IX), then the monomers of formula (VI) are methacrylic esters.

Poly(alkyl(meth)acrylates) comprise as monomers preferably 40 to 100% by weight of methacrylic esters, particularly preferably 70 to 100% by weight of methacrylic esters and more preferably from 80 to 100% by weight of methacrylic esters, each based on the total amount of the poly(alkyl(meth)acrylates).

In another preferred embodiment, the poly(alkyl(meth)acrylates) comprise as monomers from 20 to 100% by weight of methyl acrylate, ethyl acrylate or a mixture thereof, preferably from 40 to 100% by weight of methyl acrylate, ethyl acrylate or a mixture thereof and particularly preferably from 50 to 100% by weight of methyl acrylate, ethyl acrylate or mixtures of thereof, each based on the total weight of the poly(alkyl(meth)acrylate).

Such polymers of monomers of the formula (VIII) with or without further monomers can be prepared in a conventional, preferably a free radical polymerization, for example an emulsion, bead, solution or bulk polymerization (cf. Kirk-Othmer, Encyclopedia of Chemical Technology 3^{rd} Ed., Vol. 1., pp. 330-342, Vol. 18, pp. 720-755, J. Wiley; H. Rauch-Puntigam, Th. Volker, Acryl-und Methacrylverbindungen). Possible initiators depending on the monomers and the type of polymerization are free radical initiators, such as peroxy or peroxo compounds and azo compounds. The amount of initiator being in general within the range from 0.001 to 0.5% by weight, based on the monomers.

Suitable initiators for an emulsion polymerization are, for example, peroxodisulfates and redox systems for a bulk polymerization not only peroxides, such as dibenzoyl peroxide or dilauroyl peroxide, but also azo compounds, for example azobisisobutyrodinitrile, similarly in the case of the solution or bead polymerization. The molecular weight may be regulated using conventional regulators, in particular mercaptans, e.g. dodecylmercaptan.

Preferably, the polymerization is carried out at elevated temperatures, for example above 50° C. The weight average molecular weight (M_{w}) is in general within the range of from 2 000 to 5 000 000 g/mol, preferably from 20 000 to 3 000 000 g/mol (determination by light scattering; cf. HoubenWeyl, Methoden der Org. Chemie, 4th edition, Volume 14/1, Georg Thieme-Verlag Stuttgart 1961).

The person skilled in the art knows that the monomers described above for the preparation of the components (b1), (b2) and (b3) can undergo changes in their structure during the polymerization reaction. Consequently, the building units of the polymers are not the same as the monomers from which they are derived. However, the person skilled in the art knows which monomers correspond to which building unit of the polymers.

Under the conditions of compounding or processing by injection molding or fused filament fabrication, virtually no transacetalization occurs between component (b1), the polyoxymethylene (POM), and component (b3), the at least one further polymer (FP), i.e. virtually no exchange of comonomer units takes place.

### Three-Dimensional Green Body

The at least one three-dimensional green body (GB) can be prepared by any method known to the skilled person, for example, by an additive manufacturing process such as a fused filament fabrication process or by injection moulding. Preferably, the at least one three-dimensional green body (GB) is prepared by a fused filament fabrication process.

The fused filament fabrication process for the production of the at least one three-dimensional green body (GB) is well known in the state of the art and detailed explained in the above-cited documents. The fused filament fabrication process is also denominated as 3D-printing process. The filaments can comprise continuous filaments and rods, pellets and/or powders.

Preferably, the fused filament fabrication process comprises the steps
i) providing a mixture (M) to a nozzle, wherein the mixture (M) comprises an inorganic powder (IP) and a binder (B), wherein the binder (B) comprises at least one polyoxymethylene (POM),
ii) heating the mixture (M) to a temperature (T_{M}),
iii) depositing the mixture (M) into a build chamber using a layer-based additive technique to form the at least one three-dimensional green body (GB).

The above-mentioned embodiments and preferences in respect of the at least one three-dimensional green body (GB) comprising an inorganic powder (IP) and a binder (B), wherein the binder (B) comprises at least one polyoxymethylene (POM), apply analogously to the mixture (M).

The mixture (M) can be prepared by any method known to the skilled person. Preferably the mixture (M) is produced by melting the binder (B) and mixing in the inorganic powder (IP) and, if appropriate, the at least one dispersant. For example, the binder (B) can be melted in a twin screw extruder at temperatures of preferably from 150 to 220° C., in particular of from 170 to 200° C. The inorganic powder (IP) is subsequently metered in the required amount into the melt stream of the binder (B) at temperatures in the same range. The inorganic powder (IP) advantageously comprises the at least one dispersant on the surface. However, the mixture (M) of the invention can also be produced by melting the binder (B) and optionally the at least one dispersant in the presence of the inorganic powder (IP) at temperatures of from 150 to 220° C., preferably of from 170 to 200° C.

A particularly preferred apparatus for metering the inorganic powder (IP) comprises as essential element a transport screw which is located in a heatable metal cylinder and transports the inorganic powder (IP) into the melt of the binder (B). The above described process has the advantage over mixing of the components at room temperature and subsequent extrusion with an increase in temperature that decomposition of polyoxymethylene (POM) used as binder as a result of the high shear forces occurring in this variant is largely avoided.

### Step b)

In step b), 0.01 to 5.0% by weight of anhydrous oxalic acid, based on the total weight of the at least one three-dimensional green body (GB), are provided.

Preferably, in step b), 0.05 to 2.5% by weight, more preferably 0.1 to 1.5% by weight, of anhydrous oxalic acid, based on the total weight of the at least one three-dimensional green body (GB), are provided.

The anhydrous oxalic acid has preferably a purity of >95%, more preferably of ≥98%.

Therefore, another object of the present invention is a process in which the anhydrous oxalic acid has a purity of ≥95%, preferably of ≥98%.

Therefore, the anhydrous oxalic acid preferably comprises at most 5% by weight, more preferably at most 2% by weight, most preferably at most 1% by weight, and particularly preferably, 0% by weight, of water, based on the total weight of the anhydrous oxalic acid.

A further suitable acid which can also be provided in step b), preferably instead of the anhydrous oxalic acid, is at least one acid selected from the group consisting of acetic acid, citric acid, malonic acid, succinic acid, maleic acid, glycolic acid and lactic acid.

However, it is also possible, in step b), to provide 0.01 to 5.0% by weight of anhydrous oxalic acid, based on the total weight of the at least one three-dimensional green body (GB), together with at least one acid selected from the group consisting of acetic acid, citric acid, malonic acid, succinic acid, maleic acid, glycolic acid and lactic acid.

### Step c)

In step c), the at least one three-dimensional green body (GB) is treated with the anhydrous oxalic acid at a temperature (T1)<140° C. in the presence of an inert gas.

Preferably, in step c), the at least one three-dimensional green body (GB) is treated with the anhydrous oxalic acid at a temperature (T1) of from 110 to 135° C., more preferably at a temperature (T1) of from 110 to 130° C.

However, it is also possible to treat the at least one three-dimensional green body (GB) with at least one acid selected from the group consisting of acetic acid, citric acid, malonic acid, succinic acid, maleic acid, glycolic acid and lactic acid at a temperature (T1)<140° C., preferably at a temperature (T1) of from 110 to 135° C., more preferably at a temperature (T1) of from 110 to 130° C., in the presence of an inert gas in step c). Further, it is also possible to treat the at least one three-dimensional green body (GB) with the anhydrous oxalic acid and at least one acid selected from the group consisting of acetic acid, citric acid, malonic acid, succinic acid, maleic acid, glycolic acid and lactic acid at a temperature (T1)<140° C., preferably at a temperature (T1) of from 110 to 135° C., more preferably at a temperature (T1) of from 110 to 130° C., in the presence of an inert gas in step c).

The inert gas can be any gas that is substantially free of oxygen and water. It is preferably selected from the group consisting of hydrogen, nitrogen and a noble gas, more preferably from nitrogen and argon.

Therefore, another object of the present invention is a process in which the inert gas is selected from the group consisting of hydrogen, nitrogen and a noble gas.

Step c) is preferably carried out in a heating chamber (HC). The heating chamber (HC) is, for example, comprised in a furnace.

The gas flow of the inert gas during step c) is preferably regulated to 0 to 5 V_{HC} h⁻¹, wherein V_{HC} is the volume of the heating chamber.

Preferably, the debinding time t_{debind} in step c) is calculated according to the following formula (X):

$${t}_{debind} = {x}^{- 1} h \cdot {mm}^{- 1} \cdot d mm \qquad ( X )$$

wherein x is 1 to 3, and d is the thickness of the thickest wall of the at least one three-dimensional green body.

In the context of the present invention the term “thickest wall of the at least one three-dimensional green body” means the thickest continuous volume from outside to outside of the at least one three-dimensional green body.

In a preferred embodiment, a furnace comprising at least two heating chambers is used. In this case, the anhydrous oxalic acid is placed in a first heating chamber (HC1) and the at least one three-dimensional green body is placed in a second heating chamber (HC2). Both heating chambers (HC1) and (HC2) are heated to a temperature (T1)<140° C., which is lower than the sublimation temperature of the anhydrous oxalic acid, preferably to a a temperature (T1) of from 110 to 135° C., more preferably at a temperature (T1) of from 110 to 130° C.

In a particularly preferred embodiment, the temperature of the heating chamber (HC2) is 0 to 20° C., preferably 5 to 15° C., and more preferably 7 to 12° C., less than the temperature of the heating chamber (HC1), provided that the temperature of all heating chambers is within the ranges indicated above.

Therefore, another object of the present invention is an apparatus, in which the inventive process is carried out, the apparatus comprising
a first heating chamber (HC1) and a second heating chamber (HC2), wherein the first heating chamber (HC1) comprises anhydrous oxalic acid and the second heating chamber (HC2) comprises at least one three-dimensional green body (GB) and wherein the first and the second heating chamber (HC1, HC2) are both heated to a temperature (T1)<140° C., wherein the temperature of the heating chamber (HC2) is 0 to 20° C. less than the temperature of the heating chamber (HC1).

In a further preferred embodiment, also a furnace comprising only one heating chamber can be used. In this case, the anhydrous oxalic acid and the at least one three-dimensional green body are placed in the same heating chamber, wherein the heating chamber is also heated to a temperature (T1)<140° C., which is lower than the sublimation temperature of the anhydrous oxalic acid, preferably to a a temperature (T1) of from 110 to 135° C., more preferably at a temperature (T1) of from 110 to 130° C. In this case, it is also possible to create an atmosphere with a controlled concentration of anhydrous oxalic acid.

It is also possible that in these furnaces, instead of anhydrous oxalic acid, at least one acid selected from the group consisting of acetic acid, citric acid, malonic acid, succinic acid, maleic acid, glycolic acid and lactic acid is placed. In addition, it is also possible that the anhydrous oxalic acid and at least one acid selected from the group consisting of acetic acid, citric acid, malonic acid, succinic acid, maleic acid, glycolic acid and lactic acid are placed in the furnace.

By performing step c), preferably part of the binder (B) is removed. Preferably, in step c), the binder (B) is removed to an extend of at least 90% by weight, more preferably of at least 95% by weight, based on the total weight of the binder (B) comprised in the at least one three-dimensional green body (GB) provided in step a).

After the removal of the binder (B) in step c), the resulting three-dimensional object is called a “three-dimensional brown body”. The three-dimensional brown body comprises the inorganic powder (IP) and the fraction of the binder (B), which was not removed during the debinding. The person skilled in the art knows that a three-dimensional brown body comprising a ceramic material as inorganic powder (IP) is also called a three-dimensional white body. However, for the purpose of the present invention, the terms “three-dimensional brown body” and “three-dimensional white body” are used synonymous and are interchangeable.

Another object of the present invention is therefore also a three-dimensional brown-body (BB), prepared by the inventive process comprising at least steps a) to c).

In a preferred embodiment, the at least one three-dimensional brown-body (BB) formed in step c) comprises from 90 to 100% by volume of the inorganic powder (IP) and from 0 to 10% by volume of the binder (B), preferably from 95 to 100% by volume of the inorganic powder (IP) and from 0 to 5% by volume of the binder (B), based on the total volume of the at least one three-dimensional brown-body (BB).

It is known to the skilled person that at the temperature (T1), the inorganic powder (IP) comprised in the at least one three-dimensional green body (GB) can undergo chemical and/or physical reactions. In particular, the particles of the inorganic powder (IP) can fuse together and the inorganic powder can undergo solid state phase transitions.

The same holds true for the binder (B). During the step c) the composition of the binder (B) can change.

Consequently, in one embodiment of the present invention, the inorganic powder (IP) and/or the binder (B) comprised in the at least one three-dimensional green body (GB) differs from the inorganic powder (IP) and/or the binder (B) comprised in the three-dimensional brown body (BB) obtained in process step c).

### Step d)

In one embodiment of the present invention, an additional step d) may be carried out.

Preferably, step c) is followed by a step d), in which the at least one three-dimensional brown body (BB) is sintered to form at least one three-dimensional sintered body (SB). Process step d) is also called sintering. The terms “process step d)” and “sintering” for the purpose of the present invention are synonymous and are used interchangeably throughout the present invention.

After the sintering, the three-dimensional object is a three-dimensional sintered body. The three-dimensional sintered body comprises the inorganic powder (IP) and is essentially free of the binder (B).

“Essentially free of the binder (B)” according to the present invention means that the three-dimensional sintered body (SB) comprises less than 5% by volume, preferably less than 2% by volume, particularly preferably less than 0.5% by volume and most preferably less than 0.01% by volume of the binder (B), based on the total volume of the three-dimensional sintered body.

It is known to the skilled person that during the sintering process the inorganic powder (IP) is sintered together to give a sintered inorganic powder. Furthermore, during the sintering process the inorganic powder (IP) can undergo chemical and/or physical reactions. Consequently, the inorganic powder (IP) comprised in the three-dimensional brown body usually differs from the sintered inorganic powder comprised in the three-dimensional sintered body.

In one embodiment of the present invention, after process step c) and before process step d), the three-dimensional brown body obtained in process step c) is heated for preferably 0.1 to 12 h, particularly preferably from 0.3 to 6 h, at a temperature of preferably from 250 to 700° C., particularly preferably from 250 to 600° C. to remove the residual binder (B) completely.

The temperature as well as the duration and the atmosphere during process step d) depend on the inorganic powder comprised in the mixture (M). The temperature programme of the sintering process, the duration and the atmosphere is in general adapted to the needs of the inorganic powder (IP) comprised in the mixture (M). Suitable conditions for process step d) are known to the skilled person.

In general, process step d) is carried out under the atmosphere of a gas that is inert with regard to the inorganic powder (IP) and the binder (B). Typical inert gases are for example nitrogen and/or argon.

Depending on the inorganic powder (IP) comprised in the mixture (M), it is also possible to carry out process step d) in air, under vacuum or in hydrogen atmosphere.

The temperature (T2) in process step d) is in general in the range of from 750 to 1600° C., preferably of from 800 to 1500° C. and particularly preferably of from 850 to 1450° C.

Preferably, step d) is carried out in a heating chamber, wherein the heating chamber is the same heating chamber (HC) in which step c) is carried out.

Another object of the present invention is therefore a process for the production of at least one three-dimensional sintered body (SB) comprising at least the following steps
a) providing at least one three-dimensional green body (GB), wherein the at least one three-dimensional green body (GB) comprises an inorganic powder (IP) and a binder (B), wherein the binder (B) comprises
   (b1) at least one polyoxymethylene (POM),
b) providing 0.01 to 5.0% by weight of anhydrous oxalic acid, based on the total weight of the at least one three-dimensional green body (GB),
c) treating the at least one three-dimensional green body (GB) with the anhydrous oxalic acid at a temperature (T1)<140° C. in the presence of an inert gas in a heating chamber (HC) to obtain a three-dimensional brown body (BB),
c1) removing the anhydrous oxalic acid, and
d) treating the three-dimensional brown body (BB) at a temperature (T2) in the range of from 750 to 1600° C. in the heating chamber (HC), wherein the heating chamber (HC) is the same heating chamber (HC) in which step c) is carried out to obtain the at least one three-dimensional sintered body (SB).

The present invention is illustrated below by reference to examples, without limitation thereto.

### EXAMPLES

### Equipment

Furnace: Carbolite Gero, horizontal tube furnace, up to 1200° C., Hydrogen KIT, 2.7 L volume
Balance: KERN PCB 3500-2

### Material and Samples

Anhydrous oxalic acid:
98%, water free, Arco Organics, CAS: 144-62-7

### Three-Dimensional Green Bodies (GB-FFF) Produced by a Fused Filament Fabrication (Fff) Process:

For the production of three-dimensional green bodies in the form of cubes (25 mm*25 mm*25 mm) by a fused filament fabrication process, an Ultrafuse 316L filament is used. Ultrafuse 316L filaments are metal-polymer composite filaments, which comprise 316L stainless steel, and POM as binder. The printer used is based on a conventional FFF printing system (Ultimaker S5, AIM 3D ExAM255) with an extrusion system of individual selectable extrusion parameters. The print bed is coated with a thin layer of a water-soluble adhesion promoter like glue (Magigoo ProMetal). The three-dimensional body is printed layer by layer while each layer consists of connected or non-connected lines. The nozzle diameters used are between 0.2 mm and 0.8 mm with varying printing temperature from 200° C. to 260° C. The printed three-dimensional green bodies (GB-FFF) are released from the print bed by dissolving the glue and submerging the print bed in water over night.

### Three-Dimensional Green Bodies (GB-MIM) Produced by Metal Injection Molding (MIM):

The three-dimensional green bodies (GB-MIM) produced by metal injection molding (MIM) are made from Catamold 17-4PH Plus. Catamold 17-4PH Plus are ready-to-mold metal-polymer composite granules for the production of sintered components in a precipitation-hardenable stainless steel type 17-4PH which comprise POM as binder, on an Arburg 270S under standard process conditions. The starting values are shown in table 1.

TABLE 1

| Zone | 1 | 2 | 3 | Nozzle |
|---|---|---|---|---|
| Barrel | 160 | 170 | 180 | 190 |
| temperature_[° C.] | | | | |
| Mold | | | 120 | |
| temperature [° C.] | | | | |
| Screw speed | | | 50 | |
| [1/min] | | | | |
| Injection speed | | | 80 | |
| [mm/s] | | | | |
| Cushion | | | 5 | |
| [mm] | | | | |
| Molding | | | 900 | |
| pressure | | | | |
| [bar] | | | | |
| Holding | | | 900 | |
| pressure | | | | |
| [bar] | | | | |
| Holding time | | | 3 | |
| [s] | | | | |
| Back pressure | | | 3 | |
| [s] | | | | |

Nitrogen:
Purity 5.0

### Experimental Description

### Inventive Examples 1a and 1b (11a and 11b)

### Step a)

Two three-dimensional green bodies (GB-FFF; 11a) and two three-dimensional green bodies (GB-MIM; 11b) as described above are provided.
Total weight of the both three-dimensional green bodies (GB-FFF): 150.0 g
Total weight of the both three-dimensional green bodies (GB-MIM): 25.6 g
Total weight of the three-dimensional bodies: 175.6 g

### Step b)

5.2 g (correspondents to 2.96% by weight based on the total weight of the three-dimensional green bodies) anhydrous oxalic acid are provided.

### Step c)

The three-dimensional green bodies (GB-FFF) and (GB-MIM) are treated with the anhydrous oxalic acid at a temperature (T1) of 120° C. for 12 h with 14 L/h nitrogen in the heating chamber (HC) of the 2.7 L tube furnace.

### Inventive Examples 2a and 2b (12a and 12b)

### Step a)

Two three-dimensional green bodies (GB-FFF; 12a) and two three-dimensional green bodies (GB-MIM; 12b) as described above are provided.
Total weight of the both three-dimensional green bodies (GB-FFF): 150.7 g
Total weight of the both three-dimensional green bodies (GB-MIM): 25.6 g
Total weight of the three-dimensional bodies: 176.3 g

### Step b)

3.6 g (correspondents to 2.04% by weight based on the total weight of the three-dimensional green bodies) anhydrous oxalic acid are provided.

### Step c)

The three-dimensional green bodies (GB-FFF) and (GB-MIM) are treated with the anhydrous oxalic acid at a temperature (T1) of 120° C. for 6 h with 14 L/h nitrogen in the heating chamber (HC) of the 2.7 L tube furnace.

### Inventive Examples 3a and 3b (13a and 13b)

### Step a)

Two three-dimensional green bodies (GB-FFF; 12a) and two three-dimensional green bodies (GB-MIM; 12b) as described above are provided.
Total weight of the both three-dimensional green bodies (GB-FFF): 150.7 g
Total weight of the both three-dimensional green bodies (GB-MIM): 25.6 g
Total weight of the three-dimensional bodies: 176.3 g

### Step b)

1.8 g (correspondents to 1.02% by weight based on the total weight of the three-dimensional green bodies) anhydrous oxalic acid are provided.

### Step c)

The three-dimensional green bodies (GB-FFF) and (GB-MIM) are treated with the anhydrous oxalic acid at a temperature (T1) of 120° C. for 6 h with 14 L/h nitrogen in the heating chamber (HC) of the 2.7 L tube furnace.

### Comparative Examples 4a and 4b (C₄a and C₄b)

### Step a)

Two three-dimensional green bodies (GB-FFF; 12a) and two three-dimensional green bodies (GB-MIM; 12b) as described above are provided.
Total weight of the both three-dimensional green bodies (GB-FFF): 150.2 g
Total weight of the both three-dimensional green bodies (GB-MIM): 25.6 g
Total weight of the three-dimensional bodies: 175.8 g

### Step b)

29.8 g (correspondents to 16.95% by weight based on the total weight of the three-dimensional green bodies) anhydrous oxalic acid are provided.

### Step c)

The three-dimensional green bodies (GB-FFF) and (GB-MIM) are treated with the anhydrous oxalic acid at a temperature of 160° C. for 12 h with 14 L/h nitrogen in the heating chamber (HC) of the 2.7 L tube furnace.

The results are shown in table 2.

TABLE 2

| Example | Weight loss [%] |
|---|---|
| I1a | 9.2 to 9.8 |
| I1b | 7.8 |
| I2a | 9.6 to 10.6 |
| I2b | 7.8 |
| I3a | 9.4 to 10.2 |
| I3b | 7.8 |
| C4a | 7.9 to 8.8 |
| C4b | 7.6 |

1.-16. (canceled)

17. A process for the treatment of at least one three-dimensional green body (GB) comprising at least the following steps
a) providing the at least one three-dimensional green body (GB), wherein the at least one three-dimensional green body (GB) comprises an inorganic powder (IP) and a binder (B), wherein the binder (B) comprises
(b1) at least one polyoxymethylene (POM),
b) providing 0.01 to 5% by weight of anhydrous oxalic acid, based on the total weight of the at least one three-dimensional green body (GB), and
c) treating the at least one three-dimensional green body (GB) with the anhydrous oxalic acid at a temperature (T1)<140° C. in the presence of an inert gas, wherein the binder (B) comprises
(b1) from 50 to 96% by weight of at least one polyoxymethylene (POM) based on the total weight of the binder (B),
(b2) from 2 to 35% by weight of at least one polyolefin (PO) based on the total weight of the binder (B),
(b3) from 2 to 40% by weight of at least one further polymer (FP) based on the total weight of the binder (B).

18. The process according to claim 17, wherein
i) the inorganic powder (IP) is a powder of at least one inorganic material selected from the group consisting of a metal, a metal alloy and a ceramic material, and/or
ii) the particle size of the inorganic powder (IP) is from 0.1 to 80 μm measured by laser diffraction.

19. The process according to claim 17, wherein
i) in step b), 0.05 to 2.5% by weight of anhydrous oxalic acid, based on the total weight of the at least one three-dimensional green body (GB), are provided, and/or
ii) in step c), the at least one three-dimensional green body (GB) is treated with the anhydrous oxalic acid at a temperature (T1) of from 110 to 135° C.

20. The process according to claim 17, wherein the at least one three-dimensional green body (GB)
i) comprises from 30 to 70% by volume of the inorganic powder (IP) and from 30 to 70% by volume of the binder (B), based on the total volume of the at least one three-dimensional green body (GB), and/or
ii) is prepared by injection molding or a fused filament fabrication process.

21. The process according to claim 17, wherein the inert gas is selected from the group consisting of hydrogen, nitrogen and a noble gas.

22. The process according to claim 17, wherein the anhydrous oxalic acid has a purity of ≥ 95%.

23. The process according to claim 17, wherein step c) is carried out in a heating chamber (HC).

24. The process according to claim 23, wherein, during step c), the gas flow of the inert gas is regulated to 0 to 5 V_{HC} h⁻¹, wherein V_{HC} is the volume of the heating chamber (HC).

25. The process according to claim 17, wherein in step c) at least one three-dimensional brown body (BB) is formed.

26. The process according to claim 17, wherein step c) is followed by a step d), in which the at least one three-dimensional brown body (BB) is sintered to form at least one three-dimensional sintered body (SB).

27. The process according to claim 26, wherein step d) is carried out in a heating chamber (HC), wherein the heating chamber (HC) is the same heating chamber (HC) in which step c) is carried out.
